(19) United States
(12) Patent Application Publication
(10) Pub. No.: US 2018/0139136 A1
(43) Pub. Date: May 17, 2018

(54) TRANSMISSION PROCESSING METHOD AND DEVICE

(71) Applicant: ZTE CORPORATION, Guangdong (CN)

(72) Inventor: Wentao YONG, Guangdong (CN)

(73) Assignee: ZTE CORPORATION, Guangdong (CN)

(21) Appl. No.: 15/574,332

(22) PCT Filed: Sep. 10, 2015
(86) PCT No.: PCT/CN2015/089384

§ 371 Date: Nov. 15, 2017

(30) Foreign Application Priority Data
May 15, 2015 (CN) 201510251366.0

(51) Int. Cl. H04L 12/803; H04L 12/801; H04L 12/707; H04L 29/06; H04L 12/24

(52) U.S. Cl. CPC H04L 47/122; H04L 47/11; H04L 45/22; H04L 69/16; H04L 41/22; H04L 45/24

(57) ABSTRACT

The present disclosure relates to a transmission processing method and device. The method comprises: receiving from a user a transfer request for transferring a flow on a transmission path where link congestion occurs to a preset path to transmit the flow, wherein the preset path is one of preset equal-cost multiple paths of the transmission path; and according to the transfer request, transferring the flow on the transmission path where link congestion occurs to the preset path to transmit the flow.

### CROSS-REFERENCE TO RELATED APPLICATION

This application is based upon and claims priority to PCT Application No. PCT/CN2015/089384, filed Sep. 10, 2015, which is based upon and claims priority to Chinese Patent Application No. 201510251366.0, filed May 15, 2015, the entire contents of which are incorporated herein by reference.

### TECHNICAL FIELD

The present disclosure relates to the communication technical field, and more particularly to a transmission processing method and device.

### BACKGROUND

For network administrators, network link traffic is a relatively important indicator, from which the administrators can learn the latest developments and changes in networks. By observing the link traffic status, the administrators can get the latest symptoms of the networks.

If traffic on a link is congested, some intelligent traffic engineering in a Software Defined Network (SDN) may schedule some traffic to other equal-cost paths to relieve the traffic pressure on the congested links and make the link traffic conditions automatically return to normal. However, in some special cases, it seems impossible to address the link congestion problem by only relying on the intelligent scheduling of the system. In other words, it is necessary for network administrators to manually intervene the link traffic in order to ensure that traffic of some important services is not congested. However, related arts cannot not achieve manual scheduling.

There is no effective solution to the problem with related arts which address the link congestion by only relying on the intelligent scheduling of the system.

This section provides background information related to the present disclosure which is not necessarily prior art.

### SUMMARY

Embodiments of the present disclosure provide a transmission processing method and device to at least solve the problem with related arts which address the link congestion by only relying on the intelligent scheduling of the system.

According to an aspect of embodiments of the present disclosure, there is provided a transmission processing method. The method includes the following steps. A transfer request is received from a user. The transfer request is used for transferring a flow on a transmission path where link congestion occurs to a preset path to transmit the flow. The preset path is one of preset equal-cost multiple paths of the transmission path. According to the transfer request, the flow on the transmission path where link congestion occurs is transferred to the preset path to transmit the flow.

According to an exemplary embodiment, according to the transfer request, transferring the flow on the transmission path where link congestion occurs to the preset path to transmit the flow, includes the following steps. For an Access Control List (ACL) of each device in the preset path, a flow rule which corresponds to an action for designating an output port is sent. According to the output flow rule, the flow on the transmission path where link congestion occurs is transferred to the preset path to transmit the flow.

According to an exemplary embodiment, before receiving from a user a transfer request for transferring a flow on a transmission path where link congestion occurs to a preset path to transmit the flow, the method further includes the following steps. Setting information for setting a flow path by the user is received. The setting information includes: Virtual Routing Forwarding (VRF), a source IP subnet/mask, a source port, a source switch, a destination IP subnet/mask, a destination port, a destination switch, or a protocol. The protocol includes any one of a Transmission Control Protocol (TCP), a User Datagram Protocol (UDP), an Internet Control Messages Protocol (ICMP), an Open Shortest Path First (OSPF) protocol, a Stream Control Transmission Protocol (SCTP), a Datagram Congestion Control Protocol (DCCP), and a Multipath Transmission Control Protocol (MPTCP).

According to an exemplary embodiment, after calculating the equal-cost multiple paths of the flow according to a setting result, the method further includes the following step. The equal-cost multiple paths of the flow are marked in a topology structure of the flow path.

According to an exemplary embodiment, the method further includes the following step. On a display interface, the topology structure of the flow path is displayed and a traffic state of the flow path is displayed in the topology structure of the flow path. The traffic state includes any one of normal, early warning, and congestion.

According to an exemplary embodiment, after according to the transfer request, transferring the flow on the transmission path where link congestion occurs to the preset path to transmit the flow, the method further includes the following step. The topology structure of the flow path is updated.

According to another aspect of embodiments of the present disclosure, there is further provided a transmission processing device, including a processor and a memory. The memory stores instructions executable by the processor. The processor is configured to receive from a user a transfer request for transferring a flow on a transmission path where link congestion occurs to a preset path to transmit the flow, the preset path being one of preset equal-cost multiple paths of the transmission path; according to the transfer request, transfer the flow on the transmission path where link congestion occurs to the preset path to transmit the flow.

According to an exemplary embodiment, the processor is configured to, for an Access Control List (ACL) of each device in the preset path, send a flow rule which corresponds to an action for designating an output port. The processor is configured to, according to the output flow rule, transfer the flow on the transmission path where link congestion occurs to the preset path to transmit the flow.

According to an exemplary embodiment, the processor is further configured to receive setting information for setting a flow path by the user. The setting information includes Virtual Routing Forwarding (VRF), a source IP subnet/mask, a source port, a source switch, a destination IP subnet/mask, a destination port, a destination switch, or a protocol. The protocol includes any one of a Transmission Control Protocol (TCP), a User Datagram Protocol (UDP), an Internet Control Messages Protocol (ICMP), an Open Shortest Path First (OSPF) protocol, a Stream Control Transmission Protocol (SCTP), a Datagram Congestion Control Protocol (DCCP), and a Multipath Transmission Control Protocol (MPTCP). The processor is configured to set the flow path according to the setting information; and calculate the equal-cost multiple paths of the flow according to a setting result.

According to an exemplary embodiment, the processor is configured to mark the equal-cost multiple paths of the flow in a topology structure of the flow path.

In the embodiments of the present disclosure, a transfer request is received from a user. The transfer request is used for transferring a flow on a transmission path where link congestion occurs to a preset path to transmit the flow. The preset path is one of preset equal-cost multiple paths of the transmission path. According to the transfer request, the flow on the transmission path where link congestion occurs is transferred to the preset path to transmit the flow. The embodiments of the present disclosure can overcome the deficiency with related arts which address the link congestion by only relying on the intelligent scheduling of the system, thereby resulting in great reduction in occurrence possibility of link congestion in the system and improved user experience.

This section provides a summary of various implementations or examples of the technology described in the disclosure, and is not a comprehensive disclosure of the full scope or all features of the disclosed technology.

### BRIEF DESCRIPTION OF THE DRAWINGS

The accompanying drawings, which constitute a part of the present disclosure, are used to provide a further understanding of the embodiments of the present disclosure. The exemplary embodiments and descriptions thereof are used to explain the present disclosure, but are not intended to unduly limit the present disclosure.

FIG. 1 is a flow chart schematically showing a transmission processing method according to an embodiment of the present disclosure.

FIG. 2 is a block diagram schematically showing a transmission processing device according to an embodiment of the present disclosure.

FIG. 3 is a block diagram schematically showing a transmission processing device according to an embodiment of the present disclosure.

FIG. 4 is a block diagram schematically showing a transmission processing device according to an embodiment of the present disclosure.

FIG. 5 is a block diagram schematically showing a transmission processing device according to an embodiment of the present disclosure.

FIG. 6 is a block diagram schematically showing a traffic scheduling device according to an exemplary embodiment of the present disclosure.

FIG. 7 is a flow chart schematically showing a transmission processing method according to an exemplary embodiment of the present disclosure.

FIG. 8 is a flow chart schematically showing a transmission processing method according to an exemplary embodiment of the present disclosure.

FIG. 9 is a flow chart schematically showing a transmission processing method according to an exemplary embodiment of the present disclosure.

FIG. 10 is a flow chart schematically showing a transmission processing method according to an exemplary embodiment of the present disclosure.

FIG. 11 is a flow chart schematically showing a transmission processing method according to an exemplary embodiment of the present disclosure.

### DETAILED DESCRIPTION

Hereinafter, the present disclosure will be described in detail with reference to the accompanying drawings and exemplary embodiments. It should be noted that, in the case of no conflict, the embodiments in the present disclosure and the features in the embodiments may be combined with each other.

An embodiment of the present disclosure provides a transmission processing method. FIG. 1 is a flow chart schematically showing a transmission processing method according to an embodiment of the present disclosure. As shown in FIG. 1, the method includes the following steps.

In step S102, a transfer request, which is used for transferring a flow on a transmission path where link congestion occurs to a preset path to transmit the flow, is received from a user. The preset path is one of preset equal-cost multiple paths of the transmission path.

In step S104, according to the transfer request, the flow on the transmission path where link congestion occurs is transferred to the preset path to transmit the flow.

By the above steps, a transfer request, which is used for transferring a flow on a transmission path where link congestion occurs to a preset path to transmit the flow, is received from a user. The preset path is one of preset equal-cost multiple paths of the transmission path. According to the transfer request, the flow on the transmission path where link congestion occurs is transferred to the preset path to transmit the flow. The embodiment of the present disclosure can overcome the deficiency with related arts which address the link congestion by only relying on the intelligent scheduling of the system, thereby resulting in great reduction in occurrence possibility of link congestion in the system and improved user experience.

There are many ways to transfer the flow on the transmission path where link congestion occurs to the preset path to transmit the flow according to the transfer request. According to an exemplary embodiment, the flow on the transmission path where link congestion occurs may be transferred to the preset path to transmit the flow using the following approach. For an ACL of each device in the preset path, a flow rule, which defines an action for designating an output port, is sent. The output port is a corresponding output port of the preset path on each device. According to the output flow rule, the flow on the transmission path where link congestion occurs is transferred to the preset path to transmit the flow.

Before receiving from a user a transfer request for transferring a flow on a transmission path where link congestion occurs to a preset path to transmit the flow, setting information for setting a flow path by the user is received. The setting information includes: Virtual Routing Forwarding (VRF), a source IP subnet/mask, a source port, a source switch, a destination IP subnet/mask, a destination port, a destination switch, or a protocol. The protocol includes any one of a Transmission Control Protocol (TCP), a User Datagram Protocol (UDP), an Internet Control Messages Protocol (ICMP), an Open Shortest Path First (OSPF) protocol, a Stream Control Transmission Protocol (SCTP), a Datagram Congestion Control Protocol (DCCP), and a Multipath Transmission Control Protocol (MPTCP). The flow path is set according to the setting information. The equal-cost multiple paths of the flow are calculated according to a setting result.

In order to clearly distinguish the equal-cost multiple paths, the equal-cost multiple paths of the flow may be marked in a topology structure of the flow path. There are many ways to mark the multiple paths. According to an exemplary embodiment, the equal-cost multiple paths may be distinguished by different colors.

In order to enable the user to conveniently determine whether congestion occurs, the topology structure of the flow path may be displayed on a display interface and a traffic state of the flow path may be displayed in the topology structure of the flow path. The traffic state includes any one of normal, early warning, and congestion. For example, if the traffic state is early warning or congestion, the flow may be dragged to one of the equal-cost multiple paths for transmission.

According to an exemplary embodiment, after according to the transfer request, transferring the flow on the transmission path where link congestion occurs to the preset path to transmit the flow, the topology structure of the flow path may further be updated.

An embodiment of the present disclosure further provides a transmission processing device, which is configured to implement the foregoing embodiments and exemplary embodiments, and details will not be repeated again. As used below, the term “module” may be a combination of software and/or hardware that achieves a predetermined function. Although the devices described in the following embodiments are preferably implemented in software, the implementation of hardware or a combination of software and hardware is also possible and can be contemplated

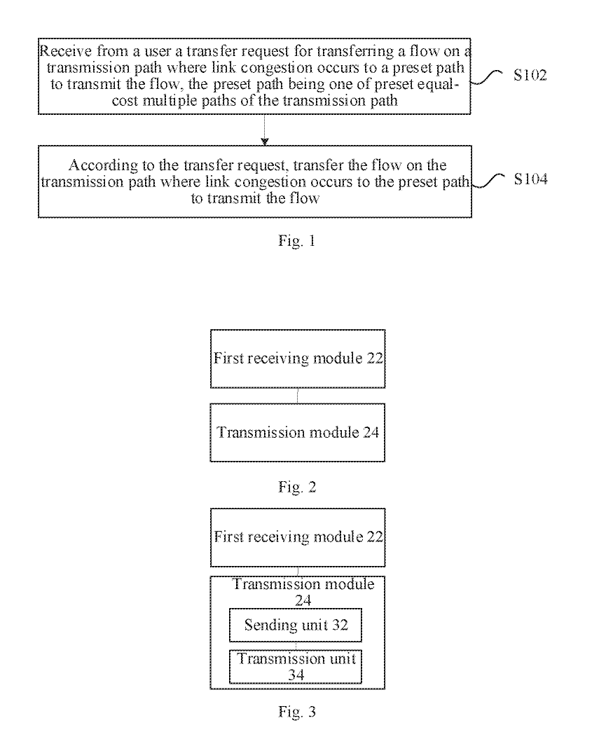

FIG. 2 is a block diagram schematically showing a transmission processing device according to an exemplary embodiment of the present disclosure. As shown in FIG. 2, the device includes a first receiving module 22 and a transmission module 24.

The first receiving module 22 is configured to receive from a user a transfer request for transferring a flow on a transmission path where link congestion occurs to a preset path to transmit the flow. The preset path is one of preset equal-cost multiple paths of the transmission path.

The transmission module 24 is configured to, according to the transfer request, transfer the flow on the transmission path where link congestion occurs to the preset path to transmit the flow.

FIG. 3 is a block diagram schematically showing a transmission processing device according to an exemplary embodiment of the present disclosure. As shown in FIG. 3, the transmission module 24 includes a sending unit 32 and a transmission unit 34.

The sending unit 32 is configured to, for an Access Control List (ACL) of each device in the preset path, send a flow rule which corresponds to an action for designating an output port.

The transmission unit 34 is configured to, according to the output flow rule, transfer the flow on the transmission path where link congestion occurs to the preset path to transmit the flow.

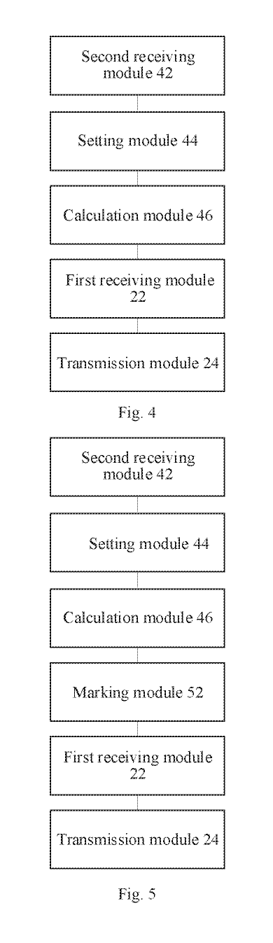

FIG. 4 is a block diagram schematically showing a transmission processing device according to an exemplary embodiment of the present disclosure. As shown in FIG. 4, the device further includes a second receiving module 42, a setting module 44 and a calculation module 46.

The second receiving module 42 is configured to receive setting information for setting a flow path by the user. The setting information includes: Virtual Routing Forwarding (VRF), a source IP subnet/mask, a source port, a source switch, a destination IP subnet/mask, a destination port, a destination switch, or a protocol, wherein the protocol includes any one of a Transmission Control Protocol (TCP), a User Datagram Protocol (UDP), an Internet Control Messages Protocol (ICMP), an Open Shortest Path First (OSPF) protocol, a Stream Control Transmission Protocol (SCTP), a Datagram Congestion Control Protocol (DCCP), and a Multipath Transmission Control Protocol (MPTCP).

The setting module 44 is configured to set the flow path according to the setting information.

The calculation module 46 is configured to calculate the equal-cost multiple paths of the flow according to a setting result.

FIG. 5 is a block diagram schematically showing a transmission processing device according to an exemplary embodiment of the present disclosure. As shown in FIG. 5, the device further includes a marking module 52.

The marking module 52 is configured to mark the equal-cost multiple paths of the flow in a topology structure of the flow path.

Aiming at the above-mentioned problem with related arts, the present disclosure will be described with reference to exemplary embodiments. The exemplary embodiments may be combined with the above described exemplary embodiments and exemplary implementations thereof.

In order to ensure that the traffic of some important services is not congested, it is necessary for a network administrator to manually intervene the link traffic. The network administrator configures the service flow that needs to be observed. When the link of the observed service flow is found to be congested, the network administrator can artificially schedule the service flow to other equivalent paths for transmission. In the exemplary embodiment, according to the static flow observation (which may be corresponding to the data flow of a certain network service) configured by the administrator, an Equal-Cost Multipath Routing (ECMP) corresponding to the flow observation is rendered on the network topology graph, and through the animation effects of streaming, the path which the flow is currently going through may be reflected. When the administrator finds that link congestion occurs in a flow transmission path which is observed by him or her, the administrator may drag the flow to other normal equal-cost paths in the network topology by a dragging manner, in order to guarantee the normal data transmission of the service flow. In ECMP, there exists a network environment in which there are many different links leading to the same destination address. If traditional routing technologies are used, the packets destined for the destination address can only use one of the links and the other links are in a backup state or an invalid state. In addition, mutual switching takes time in a dynamic routing environment. The equal-cost multipath routing protocol can use multiple links simultaneously in the network environment, which not only increases the transmission bandwidth but also backs up data transmission of invalid links without delay and packet loss.

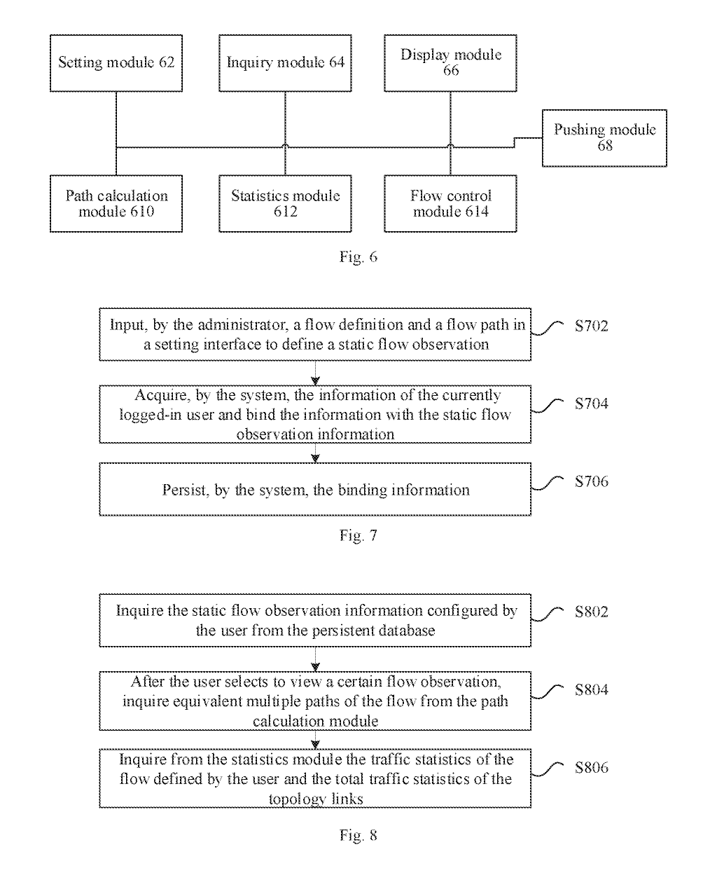

An embodiment of the present disclosure provides a traffic scheduling device. FIG. 6 is a block diagram schematically showing a traffic scheduling device according to an exemplary embodiment of the present disclosure. As shown in FIG. 6, the device includes a setting module 62, an inquiry module 64, a display module 66, a pushing module 68, a path calculation module 610, a statistics module 612, and a flow control module 614. The functions of these modules can be collectively realized by the above described modules and units. The modules will be described below.

The setting module 62 is configured to set a static flow observation, including a flow definition and a flow path. The flow definition contains Virtual Routing Forwarding (VRF), and a 5-tuple (a source IP subnet/mask, a source port, a destination IP subnet/mask, a destination port, a protocol), and these parameters all support globbing. The flow path contains the source switch and the destination switch. Since the 5-tuple supports globbing, the path cannot be determined by the 5-tuple, or there may be too many paths. Therefore, the source and destination switches need to be specified to determine the path, and the source and destination switches need to match the 5-touple. Data configured by different administrators are isolated from each other. FIG. 7 is a flow chart schematically showing a transmission processing method according to an exemplary embodiment of the present disclosure. As shown in FIG. 7, the method may include the following steps.

In step S702, the administrator inputs a flow definition and a flow path in a setting interface to define a static flow observation.

In step S704, the system acquires the information of the currently logged-in user and binds the information with the static flow observation information.

In step S706, the system persists the binding information.

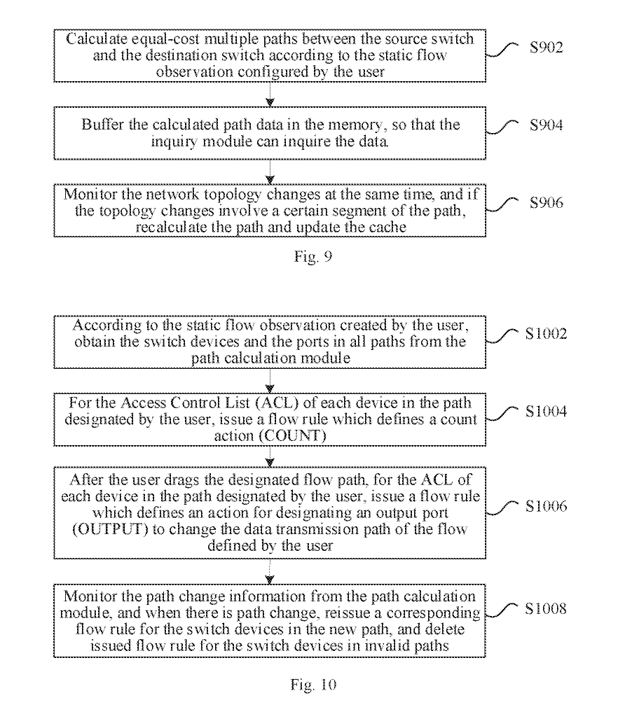

The inquiry module 64 is configured to inquire information set by the administrator, such as the static flow observation, the flow path, the flow statistics, and the link traffic and so on, to facilitate the administrator to monitor the running status of the network and determine whether to drag flows to change the flow path to ensure the normal transmission of the service data. FIG. 8 is a flow chart schematically showing a transmission processing method according to an exemplary embodiment of the present disclosure. As shown in FIG. 8, the method may include the following steps.

In step S802, the static flow observation information configured by the user is inquired from the persistent database.

In step S804, after the user selects to view a certain flow observation, equivalent multiple paths of the flow are inquired from the path calculation module.

In step S806, the traffic statistics of the flow defined by the user and the total traffic statistics of the topology links are inquired from the statistics module 612.

The display module 66 is configured to display in the network topology graph the static flow observation information configured by the administrator, the flow path, the flow statistics of the flow, the visualization of the link traffic, and provide operations for adding, deleting and modifying the static flow observation and for dragging the flow path, and so on.

The pushing module 68 is configured to push the network topology changes, the static flow configuration changes, and the flow path changes to the front-end for display.

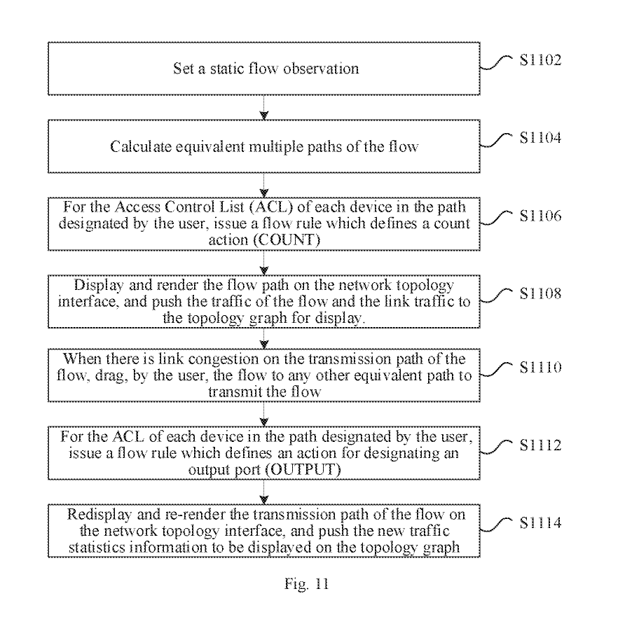

The path calculation module 610 is configured to, according to the source and destination switches defined in the flow observation configured by the administrator, calculate the ECMP between the two switches. Every time when the system is started, according to the source and destination switches defined in the flow observation configured by the administrator, the ECMP between the two switches is calculated, and topology changes are monitored. When the topology is changed, the paths between devices are calculated again. FIG. 9 is a flow chart schematically showing a transmission processing method according to an exemplary embodiment of the present disclosure. As shown in FIG. 9, the method may include the following steps.

In step S902, equal-costs multiple paths between the source switch and the destination switch are calculated according to the static flow observation configured by the user.

In step S904, the calculated path data is buffered in the memory, so that the inquiry module can inquire the data.

In step S906, the network topology changes are monitored at the same time. If the topology changes involve a certain segment of the path, the path is recalculated and the cache is updated.

The statistics module 612 is configured to perform statistics on the traffic of the flows and the traffic of the links.

The flow control module 614 is configured to, according to the static flow observation created by the user, obtain from the path calculation module switch devices and ports in all paths, and for the Access Control List (ACL) of each device in the path designated by the user, send a flow rule which defines a count action (COUNT). After the user drags the designated flow path, for the ACL of each device in the path designated by the user, a flow rule which defines an action for designating an output port (OUTPUT) is sent to change the data transmission path of the flow defined by the user. At the same time, the flow control module monitors the path change information from the path calculation module, and when there is path change, the flow control module resends a corresponding flow rule for the switch devices in the new path. For the switch devices in invalid paths, the flow control module deletes the issued flow rule. FIG. 10 is a flow chart schematically showing a transmission processing method according to an exemplary embodiment of the present disclosure. As shown in FIG. 10, the method includes the following steps.

In step S1002, according to the static flow observation created by the user, the switch devices and the ports in all paths are obtained from the path calculation module.

In step S1004, for the Access Control List (ACL) of each device in the path designated by the user, a flow rule which defines a count action (COUNT) is issued.

In step S1006, after the user drags the designated flow path, for the ACL of each device in the path designated by the user, a flow rule which defines an action for designating an output port (OUTPUT) is issued to change the data transmission path of the flow defined by the user.

In step S1008, the path change information from the path calculation module is monitored. When there is path change, a corresponding flow rule is reissued for the switch devices in the new path. For the switch devices in invalid paths, the issued flow rule is deleted.

An exemplary embodiment provides a traffic scheduling method. The method further includes defining a static flow observation, and the definition includes a flow definition and a flow path. The flow definition contains VRF, a source IP subnet/mask, a source port, a destination IP subnet/mask, a destination port, and a protocol. The protocol includes TCP, UDP, ICMP, OSPF, SCTP, DCCP, or MPTCP. These parameters all support globbing. The flow path further includes a source switch device and a destination switch device. The equal-cost multiple paths corresponding to the static flow observation are visualized on the display interface. In the network topology graph, the paths are rendered by bolding the links, and the transmission path which the flow is currently going through is rendered by adding an animation effect of flowing along a direction. The link traffic can also be visualized to intuitively display the link traffic state. The link traffic state may be one of normal, early warning, and congestion. In the network topology graph, different colors may be used to mark links, for example, green, orange, and red may be used to render links. If the traffic on a certain path is early warning or congested, the administrator is allowed to drag the flow path in the network topology graph to other equal-cost paths.

In the exemplary embodiment, according to the static flow observation created by the user, a plurality of equivalent paths corresponding to the flow observation and the transmission paths of the current flow are rendered in the network topology. At the same time, the network topology graph renders the links by three states, i.e., “normal”, “early warning” and “congestion”. When the user finds that a certain link in the current transmission path of the configured flow is congested, the flow can be dragged to other equivalent paths for transmission by manual dragging in the network topology graph, so as to ensure that the service data of interest to the user can be transmitted normally. FIG. 11 is a transmission processing method according to an exemplary embodiment of the present disclosure. As shown in FIG. 11, the method may include the following steps.

In step S1102, a static flow observation is set.

In step S1104, equivalent multiple paths of the flow are calculated.

In step S1106, for the Access Control List (ACL) of each device in the path designated by the user, a flow rule which defines a count action (COUNT) is issued.

In step S1108, the flow path is displayed and rendered on the network topology interface, and the traffic of the flow and the link traffic are pushed to the topology graph for display.

In step S1110, when there is link congestion on the transmission path of the flow, the user drags the flow to any other equivalent path to transmit the flow.

In step S1112, for the ACL of each device in the path designated by the user, a flow rule which defines an action for designating an output port (OUTPUT) is issued.

In step S1114, the transmission path of the flow is redisplayed and re-rendered on the network topology interface, and the new traffic statistics information is pushed to be displayed on the topology graph.

It is obvious to those skilled in the art that each module or each step of the present disclosure described above can be implemented by common computing devices, which can be centralized on a single computing device or distributed over a network formed by multiple computing devices. The steps of the present disclosure may be implemented with program codes executable by a computing device, and the codes may be stored in a storage device for execution by a computing device. In some cases, the shown or described steps may be performed in an order different from that described herein, or may be made into individual integrated circuit modules, or a plurality of modules or steps may be made into a single integrated circuit module. The present disclosure is not limited to any specific combination of hardware and software.

The foregoing descriptions are merely exemplary embodiments of the present disclosure and are not intended to limit the present disclosure. For those skilled in the art, the present disclosure may have various modifications and changes. Any modification, equivalent replacement, improvement and the like within the spirit and principle of the present disclosure should be included in the protection scope of the present disclosure.

### INDUSTRIAL APPLICABILITY

The above embodiments of the present disclosure may be applied in the communication technical field. The embodiments of the present disclosure can overcome the deficiency with related arts which address the link congestion by only relying on the intelligent scheduling of the system, thereby resulting in great reduction in occurrence possibility of link congestion in the system and improved user experience.

1. A transmission processing method, comprising:
receiving from a user a transfer request for transferring a flow on a transmission path where link congestion occurs to a preset path to transmit the flow, wherein the preset path is one of preset equal-cost multiple paths of the transmission path; and
according to the transfer request, transferring the flow on the transmission path where link congestion occurs to the preset path to transmit the flow.

2. The method according to claim 1, wherein according to the transfer request, transferring the flow on the transmission path where link congestion occurs to the preset path to transmit the flow, comprises:
for an Access Control List (ACL) of each device in the preset path, sending a flow rule which corresponds to an action for designating an output port; and
according to the output flow rule, transferring the flow on the transmission path where link congestion occurs to the preset path to transmit the flow.

3. The method according to claim 1, wherein before receiving from a user a transfer request for transferring a flow on a transmission path where link congestion occurs to a preset path to transmit the flow, the method further comprises:
receiving setting information for setting a flow path by the user, wherein the setting information comprises: Virtual Routing Forwarding (VRF), a source IP subnet/mask, a source port, a source switch, a destination IP subnet/mask, a destination port, a destination switch, or a protocol, wherein the protocol comprises any one of a Transmission Control Protocol (TCP), a User Datagram Protocol (UDP), an Internet Control Messages Protocol (ICMP), an Open Shortest Path First (OSPF) protocol, a Stream Control Transmission Protocol (SCTP), a Datagram Congestion Control Protocol (DCCP), and a Multipath Transmission Control Protocol (MPTCP);
setting the flow path according to the setting information; and
calculating the equal-cost multiple paths of the flow according to a setting result.

4. The method according to claim 3, wherein after calculating the equal-cost multiple paths of the flow according to a setting result, the method further comprises:
marking the equal-cost multiple paths of the flow in a topology structure of the flow path.

5. The method according to claim 3, further comprising:
displaying on a display interface the topology structure of the flow path and displaying a traffic state of the flow path in the topology structure of the flow path, wherein the traffic state comprises any one of normal, early warning, and congestion.

6. The method according to claim 3, wherein after according to the transfer request, transferring the flow on the transmission path where link congestion occurs to the preset path to transmit the flow, the method further comprises:
updating the topology structure of the flow path.

7. A transmission processing device, comprising:
a processor; and
a memory for storing instructions executable by the processor;
wherein the processor is configured to:
receive from a user a transfer request for transferring a flow on a transmission path where link congestion occurs to a preset path to transmit the flow, wherein the preset path is one of preset equal-cost multiple paths of the transmission path; and
according to the transfer request, transfer the flow on the transmission path where link congestion occurs to the preset path to transmit the flow.

8. The device according to claim 7, wherein the processor is configured to:
for an Access Control List (ACL) of each device in the preset path, send a flow rule which corresponds to an action for designating an output port; and
according to the output flow rule, transfer the flow on the transmission path where link congestion occurs to the preset path to transmit the flow.

9. The device according to claim 7, wherein the processor is further configured to:
receive setting information for setting a flow path by the user, wherein the setting information comprises: Virtual Routing Forwarding (VRF), a source IP subnet/mask, a source port, a source switch, a destination IP subnet/mask, a destination port, a destination switch, or a protocol, wherein the protocol comprises any one of a Transmission Control Protocol (TCP), a User Datagram Protocol (UDP), an Internet Control Messages Protocol (ICMP), an Open Shortest Path First (OSPF) protocol, a Stream Control Transmission Protocol (SCTP), a Datagram Congestion Control Protocol (DCCP), and a Multipath Transmission Control Protocol (MPTCP);
set the flow path according to the setting information; and
calculate the equal-cost multiple paths of the flow according to a setting result.

10. The device according to claim 9, wherein the processor is further configured to:
mark the equal-cost multiple paths of the flow in a topology structure of the flow path.

11. A non-transitory computer-readable storage medium having stored therein instructions that, when executed by a processor of a device, causes the device to perform a transmission processing method, the method comprising:
receiving from a user a transfer request for transferring a flow on a transmission path where link congestion occurs to a preset path to transmit the flow, wherein the preset path is one of preset equal-cost multiple paths of the transmission path; and
according to the transfer request, transferring the flow on the transmission path where link congestion occurs to the preset path to transmit the flow.
